(19) United States
(12) Patent Application Publication
(10) Pub. No.: US 2021/0388715 A1
(43) Pub. Date: Dec. 16, 2021

(54) METHOD FOR DETERMINING A LITHOLOGIC INTERPRETATION OF A SUBTERRANEAN ENVIRONMENT

(71) Applicant: SHELL OIL COMPANY, Houston, TX (US)

(72) Inventors: Neilkunal PANCHAL, Houston, TX (US); Sami Mohammed Khair SULTAN, Houston, TX (US); Jeong Hwan KOOK, Houston, TX (US); David THANOON, Houston, TX (US)

(21) Appl. No.: 17/279,487

(22) PCT Filed: Jul. 30, 2019
(86) PCT No.: PCT/US2019/044054

§ 371 Date: Mar. 24, 2021

Related U.S. Application Data
(60) Provisional application No. 62/736,749, filed on Sep. 26, 2018.

(51) Int. Cl. E21B 47/04; E21B 47/26; E21B 47/003

(52) U.S. Cl. CPC E21B 47/04; E21B 47/003; E21B 47/26

(57) ABSTRACT

A method for determining a depth of a target layer in a subterranean formation involves obtaining sequences of downhole and offset data. The downhole and offset data are discretized, and labels assigned to the discretized data. The sequences of labeled downhole and offset data are compared to determine a subsequence alignment. A depth for the target layer can thereby be determined.

### FIELD OF THE INVENTION

The present invention relates to interpretation of subterranean environments, and, in particular, to a method for determining a depth of a target layer in a subterranean formation.

### BACKGROUND OF THE INVENTION

In the drilling of a borehole in a subterranean formation, it is known to take measurements, for example by MWD or LWD, to obtain information about the subterranean environment, drilling depth, drill bit conditions, and the like. It is also known to use the MWD/LWD data for one or more existing wells for making decisions when drilling a new well path. The existing well is often referred to as an offset well. Data from the offset well may be used directly or incorporated into an earth or formation model.

For example, U.S. Pat. No. 9,442,211B2 (Schlumberger) describes a method for determining the presence and position of one or more resistivity contrasts in a formation ahead of a well drilling system. Resistivity measurements are made using a downhole tool and compared to an expected response of the downhole tool based on a formation model. In this way, a presence and position of a resistivity contrast is produced for vertical and horizontal well decisions. Measurements are sensitive to the surrounding formation, including the determination of a bed ahead of the drill bit if one is present. A simulated response can be produced by modeling a well bore with no boundary ahead of the drill bit. The difference between the actual response and the modeled response is computed via a control system. If the difference is zero, a conclusion can be made that there is no bed ahead of the drill bit, but if the difference is not zero, a conclusion can be made that the difference is attributable to the presence of a bed ahead of the drill bit.

U.S. Pat. No. 9,045,967B2 (Schlumberger) relates to a method for controlling and monitoring a drilling operation in which a plurality of mathematical solutions is generated from a panistic inversion, more specifically a Monte-Carlo type inversion, based on measured data obtained from the drilling tool and one or more earth models. The mathematical solutions are used to determine if the measured data exceeds a probability risk threshold associated with the drilling operation. The panistic inversion retrieves a stored selection of earth models for the desired geographic region associated with the drilling operation. A plurality of solutions is generated by the panistic inversion model using measured data. Any solution from the panistic inversion that falls significantly outside or away from the baseline or does not make sense when compared to a parameter is earmarked or flagged to be removed from further consideration and/or use by the panistic inversion and risk estimate module.

WO2010/132927A1 (GeoMole) describes forward-looking borehole radar for determining proximity of an adjacent interface of different seams or layers in a subterranean formation. A drill bit is electromagnetically excited for detecting impedance changes near the drill bit during drilling. The detected impedance changes are processed to determine a proximity of the drill bit to a targeted interface between different layers during drilling. As described in the GeoMole application, the method may further include sensing when the drill bit is at a predetermined distance from the interface and generating an alert to alert a driller operating the drill string of the proximity of the drill bit to a coal seam interface. The alert signal may be derived from a comparison, either mathematically based or subjective, of patterns emerging from the hole being drilled with those recorded in earlier holes. Embodiments of the GeoMole method may utilize seismic geostopping, whereby the output signals of accelerometers positioned near the bit are processed in order to detect an elastic response of the formation to the action of the bit during drilling, whereby changes in the detected elastic response herald approach of the bit to a layer interface, permitting geostopping prior to piercing of that interface.

While the overall pattern of gamma ray signals will be similar across a subterranean formation for nearby wells, the intensity of the measurements may be recorded in different scales. Also, the data may include noisy values. Accordingly, conventional methods that rely on pattern matching for determining true vertical depth (TVD) are subject to error and may be susceptible to extreme or outlying values, as suggested in U.S. Pat. No. 9,045,967B2. Also, in the inventors' experience, a particular point in a gamma-ray log may be mapped first to a TVD “X” and then to a TVD “X+n,” based on errors in pattern matching with offset well data. Using a minimum variance matching technique, however, is computationally expensive and cannot be scaled to differently scaled data sets. Furthermore, greedy approaches can only work with linear cost functions.

There is a need for a method for determining a depth of a target layer in a subterranean formation that is scalable, robust to noise, and independent of differences in intensity scales between data sets.

### SUMMARY OF THE INVENTION

According to one aspect of the present invention, there is provided a method for determining a depth of a target layer in a subterranean formation, comprising the steps of: obtaining a sequence of downhole data for a well path; obtaining a sequence of offset data for an offset well at a location remote from the well path; discretizing the downhole data and the offset data; assigning labels to the discretized downhole data and the discretized offset data to generate a sequence of labeled downhole data and a sequence of labeled offset data; comparing the sequence of labeled downhole data and the sequence of labeled offset data to determine a subsequence alignment; and determining the depth for the target layer.

### BRIEF DESCRIPTION OF THE DRAWINGS

The present invention will be better understood by referring to the following detailed description of preferred embodiments and the drawings referenced therein, in which:

FIG. 1 illustrates a comparison of downhole data for a current well path with data for three offset wells; and

FIGS. 2A-2F illustrate one embodiment of the method of the present invention for a wellbore being drilled as compared with an offset well.

### DETAILED DESCRIPTION OF THE INVENTION

The present invention relates to a method for determining a depth for a target layer in a subterranean formation. The depth may be a true vertical depth (TVD), a relative stratigraphic depth (RSD), or other depth of interest. The method of the present invention is scalable, robust to noise and independent of differences in intensity scales between data sets. The method is a computer-implemented method.

Conventional methods for determining TVD or RSD for a target layer in a formation often rely on pattern matching of sequences of downhole data with sequences of offset data. However, when scales of data are different in some, part, or all of the sequences, outliers or heterogenous points, as well as missing signals, can create an erroneous pattern match and produce an incorrect TVD or RSD determination for the target layer. Also, data may include noise and/or may have already been filtered, which may further result in errors in determining TVD or RSD by pattern matching.

The method of the present invention overcomes the disadvantages of conventional methods discretizing the data, assigning labels to the discretized data and generating a sequence of labeled downhole data for comparing to a sequence of labeled offset data to determine subsequence alignment. The subsequence alignment can provide a depth determination for the respective downhole data and, ultimately, for a target layer in a subterranean formation.

The method of the present invention can be used while drilling a wellbore, and/or in post-processing of a well.

During a drilling operation, the method preferably includes a step of determining a deepest vertical depth of a well path for stopping the substantially vertical portion of a drilling operation based on the depth determination for the target layer. Accordingly, this method is advantageously used in a lithologic interpreting operation with numerical metrics to determine the confidence and accuracy of such an interpretation.

As a further advantage, the method of the present invention includes a step of determining the risk and probability of drilling events. For example, the method of the present invention includes the step of determining a sequence of approaching formation changes. Formation changes can include, for example, without limitation, changes in rock type in formation layers, formation layer interfaces and combinations thereof. Drilling parameters for the formation changes may be controlled in view of the determination of the sequence.

For example, the method of the present invention can be used to determine whether the drill bit is approaching an interface of harder rock, where it may be desirable to slow the rpm of a drill bit before contact. As another example, the method of the present invention can be used to determine whether the drill bit is approaching certain stresses in the rock that may cause the drill bit to slide with respect to the intended well path. As a further example, the method of the present invention can be used to determine whether the drill bit is approaching a salt dome, which if not correctly accounted for, creates a safety risk if the drilling operation resulted in collapse of the salt dome.

A sequence of formation layers also provides information for a drilling operation, for signifying when the well path should deviate from vertical for approaching a landing position for a follow-on substantially horizontal well path.

Drilling parameters that can be controlled in the method of the present invention, include, for example, without limitation, trajectory, weight-on-bit, rpm, mud weight, drill bit speed, tool curvature, roll angle, and combinations thereof.

In accordance with the method of the present invention, a sequence of downhole data for a wellbore is obtained. Also, one or more sequences of offset well data are also obtained, for example, from a well remote from the wellbore of interest. Preferably, the offset data has substantially similar geological features. Typically, data from nearby offset wells will provide a better-quality match to downhole data. Preferably, downhole and offset data may include sensor-acquired data and/or output data. Example of sensor data include, without limitation, gamma-ray data, density data, resistivity data, and combinations thereof. Real-time sensor measurements are made while drilling. Examples of output data include, without limitation, rate of penetration data, mechanical specific energy, and combinations thereof.

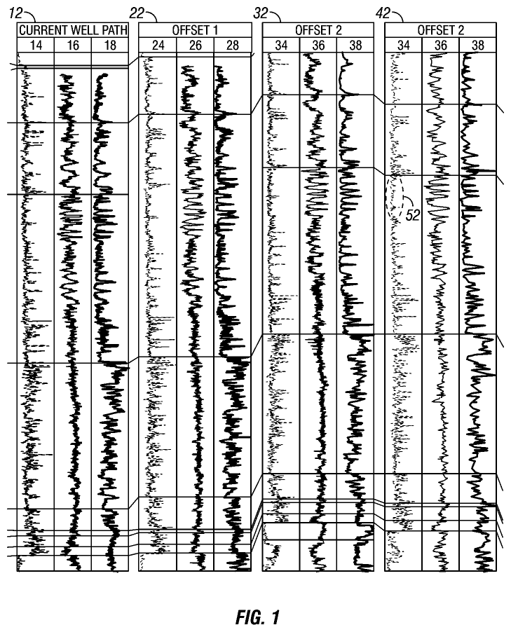

FIG. 1 illustrates one example of downhole data and offset data that can be used in the method of the present invention. Downhole data 12 includes a gamma-ray log 14, density log 16 and a resistivity log 18. Offset data includes Offset 1 data 22, Offset 2 data 32, and Offset 3 data 42. Offset 1 data 22 includes a gamma-ray log 24, a density log 26 and a resistivity log 28. Offset 2 data 32 includes a gamma-ray log 34, a density log 36 and a resistivity log 38. Finally, Offset 3 data 42 includes a gamma-ray log 44, a density log 46 and a resistivity log 48.

The method of the present invention may be used on some or all of the offset data from all of the offset wells, or only one type from one offset wells.

The variability of the data in FIG. 1 illustrates the challenges of pattern matching, for example, while drilling. FIG. 1 also illustrates how the depth and thickness of the layers can change within a formation. Interfaces between layers are depicted by the connected horizontal lines in FIG. 1.

When data is missing, for example, within a data sequence or between offset wells, it may be desirable to synthetically augment the offset data by interpolation or by inference. For example, data about a layer in a formation may be missing in an offset well and that information may be synthetically generated to augment the offset data.

The downhole data and the offset data is then discretized. The discretization step may be applied to a data log, for example, the gamma-ray log 34, as a whole. Preferably, subsequences of data having a reduced amplitude as compared to the remainder of the log data may be discretized separately. For example, in the gamma-ray log 44 for the Offset 3 data 42, a portion of the sequence, circled as portion 52, has a significantly reduced amplitude. By discretizing a subsequence independently of the remainder of the data, a better indication of any patterns there will be more evident and the scale and amplitude of the data is no longer a factor for pattern matching.

The discretizing step preferably involves splitting the downhole data and offset data sequences into intervals representing the minimum, maximum and intermediate values for respective sequences. Preferably, the number of intervals is in a range from 4 to 10, and more preferably, 4 to 6. Most preferably, the number of intervals is 4.

In accordance with the present invention, labels are assigned to the discretized downhole and offset data to generate sequences of labeled downhole data and labeled offset data. The sequences of labeled data are then compared to determine a subsequence alignment by pattern matching the labels. The method of the present invention finds a best match in the pattern of labels. It is not important to match all points to do so. Rather, the method of the present invention finds the best subsequences alignment with a subset of data points. By comparing the data, the depth for a target layer and preceding layers may be determined.

In a preferred embodiment, a benchmark score can be determined by quantifying alignment and patterns of a well path's downhole data to similar offset data logs. Preferably, the benchmark score is a range of from 0 to 1 for each formation match, with 1 being a perfect pattern match. The benchmark score can be used to establish user confidence in the interpretation.

### Example

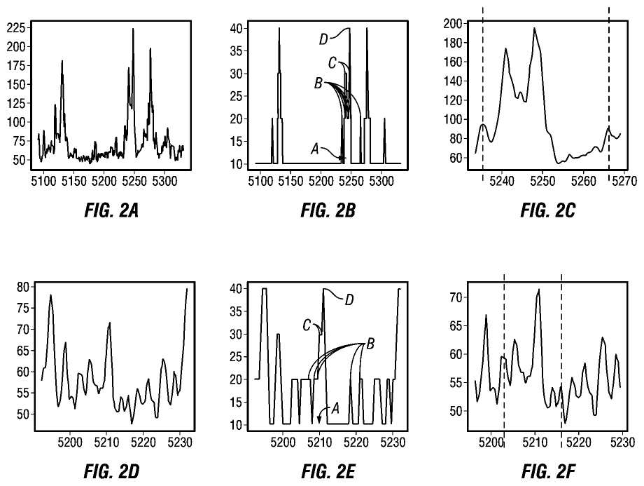

An example of the method of the present invention is illustrated in FIGS. 2A-2F. FIG. 2A represents a sequence of gamma-ray signals observed while drilling a wellbore. This portion of the log data shows a range of API radioactivity units from 40-225 for TVD in the range of 1546-1631 m (5075-5350 feet). FIG. 2D illustrates filtered gamma-ray data from an offset well for depths ±30 m (100 feet) of the TVD in FIG. 2A. As illustrated, the filtered API radioactivity units range from 45-80 for depths in a range from 1585-1628 m (5200-5340 feet).

The data for each of the gamma-ray logs was discretized into 4 equal intervals and labeled. Pattern matching is demonstrated with a few labels in FIGS. 2B and 2E. For example, A is a label for data points with the minimum discretized value and D is a label for data points with the maximum discretized value, while B and C are labels for intermediate intervals.

The labels for the downhole data in FIG. 2B were compared with the labels for the offset data in FIG. 2E to determine where a pattern matched. For this example, a pattern is shown in FIG. 2B as . . . -B-A-B-C-C-B-B-C-D-B-A-B- . . . . A best-match pattern is depicted in FIG. 2F as . . . -B-A-B-B-C-C-D-A-B-B- . . . . Matched gamma-ray logs are shown in in FIGS. 2C and 2F, respectively. The dashed vertical lines in FIGS. 2C and 2F show a subsequence alignment for a TVD range of about 1594-1605 m (5234-5266 feet) in the wellbore being drilled (see FIG. 2C) with a TVD range of about 1586-1589 m (5203-5216 feet) in the offset well. This pattern match was not readily apparent by comparing the downhole and offset gamma-ray logs in FIGS. 2A and 2D, respectively, due to differences in data intensity scales, noise and prior filtering of the offset data.

This example illustrates how the method of the present invention can be used for determining a TVD for a target layer in a subterranean formation that is scalable, robust to noise, and independent of differences in intensity scales between data sets.

While preferred embodiments of the present invention have been described, it should be understood that various changes, adaptations and modifications can be made therein within the scope of the invention(s) as claimed below.

1. A method for determining a depth of a target layer in a subterranean formation, comprising the steps of:
obtaining a sequence of downhole data for a well path;
obtaining a sequence of offset data for an offset well at a location remote from the well path;
discretizing the downhole data and the offset data;
assigning labels to the discretized downhole data and the discretized offset data to generate a sequence of labeled downhole data and a sequence of labeled offset data;
comparing the sequence of labeled downhole data and the sequence of labeled offset data to determine a subsequence alignment; and
determining the depth for the target layer.

2. The method of claim 1, wherein the well path is substantially vertical.

3. The method of claim 2, wherein the downhole data is acquired while drilling a wellbore.

4. The method of claim 3, further comprising the step of determining a deepest vertical depth for stopping the substantially vertical portion of a drilling operation based on the true vertical depth for the target layer.

5. The method of claim 1, further comprising the step of determining a probability of approaching an interface between layers in the subterranean formation.

6. The method of claim 1, further comprising the step of determining the risk and probability of drilling events.

7. The method of claim 6, further comprising the steps of determining a sequence of approaching formation changes selected from changes in rock type in formation layers, formation layer interfaces and combinations thereof, and controlling drilling parameters for the formation changes.

8. The method of claim 7, wherein the step of controlling drilling parameters is selected from the group consisting of trajectory, weight-on-bit, rpm, mud weight, drill bit speed, tool curvature, roll angle, and combinations thereof.

9. The method of claim 1, wherein the offset data further comprises synthetic data for an equivalent offset well.

10. The method of claim 1, wherein the discretizing step comprises splitting the sequence of downhole data and the sequence of offset data into intervals from minimum data point to maximum values for the respective sequences.

11. The method of claim 10, wherein the number of intervals is in a range from 4 to 6.

12. The method of claim 10 the number of intervals is 4.

13. The method of claim 1, wherein the downhole data and the offset data are selected from the group consisting of sensor data, output data and combinations thereof.

14. The method of claim 13, wherein the sensor data is selected from the group consisting of gamma-ray data, density data, resistivity data, and combinations thereof.

15. The method of claim 13, wherein the output data is selected from the group consisting of rate of penetration data, mechanical specific energy, and combinations thereof.

16. The method of claim 1, further comprising the step of quantifying subsequence alignment and patterns of a well path's downhole data to offset data logs to create a benchmark score.

17. The method of claim 16, wherein the benchmark score is in a range of from 0 to 1.
